(19) United States
(12) Patent Application Publication
(10) Pub. No.: US 2006/0087294 A1
(43) Pub. Date: Apr. 27, 2006

(54) Gas turbine apparatus

(75) Inventors: Tadashi Kataoka, Ohta-ku (JP); Nobuhiko Hamano, Ohta-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: EBARA CORPORATION, Ohta-ku (JP)

(21) Appl. No.: 11/258,270

(22) Filed: Oct. 26, 2005

(30) Foreign Application Priority Data
Oct. 27, 2004 (JP) 2004-312954

(51) Int. Cl. G05F 1/00

(52) U.S. Cl. 323/201

(57) ABSTRACT

A gas turbine apparatus has an air compressor for compressing air, a combustor capable of combusting the air compressed by the air compressor, and a first fuel supply system configured to supply a fuel to the combustor. The gas turbine apparatus also has a turbine rotatable by a gas discharged from the combustor, a recuperator for exchanging heat between the air supplied from the air compressor to the combustor and an exhaust gas discharged from the turbine, and a gas introduction device configured to introduce a combustible gas into the exhaust gas discharged from the turbine.

### BACKGROUND OF THE INVENTION

1. Field of the Invention

The present invention relates to a gas turbine apparatus, and more particularly to a gas turbine apparatus used in a micro-gas turbine power generating system or the like. The present invention also relates to a gas turbine power generating system employing such a gas turbine apparatus to generate electric power.

2 Description of the Related Art

For example, a digestion gas produced in a digestion process of biomass and a pyrolysis gas produced in a gasification process of biomass have a small heating value per unit volume. While a town gas has a lower heating value of about 50,233 kJ/kg (12,000 kcal/kg), a digestion gas has a lower heating value of about 25,116 kJ/kg (6,000 kcal/kg), which is a half of the lower heating value of the town gas. A pyrolysis gas has a lower heating value of about 5,023 kJ/kg (1,200 kcal/kg), which is a tenth of the lower heating value of the town gas.

Generally, a fuel gas is less likely to be ignited and to be stably combusted as the lower heating value of the fuel gas is smaller. Particularly, gases having a lower heating value smaller than about 6,279 kJ/kg (1,500 kcal/kg) have difficulty in maintaining combustion in a heat engine such as a gas turbine or a gas engine.

In order to combust such gases having a small heating value in a combustor of a gas turbine, a gas to be supplied to the gas turbine should be pressurized by a gas compressor. For example, when a digestion gas, which has about a half of the heating value of a town gas, is used in a gas turbine apparatus, the volume of the gas to be pressurized should be two times as large as that of a town gas in order to obtain the same output as in the case of the town gas. Accordingly, a gas having a small heating value requires a large-sized gas compressor and increases power loss for pressurizing the gas. Thus, when a gas having a small heating value is used in a gas turbine apparatus, initial cost for the apparatus is increased, and a generation efficiency is lowered.

Recently, the following attempts have been made to utilize a gas having a small heating value in a heat engine such as a gas turbine or a gas engine. A gas having a small heating value is refined to a high degree to increase its heating value. Alternatively, a gas having a small heating value is mixed with a fuel gas having a large heating value such as a propane gas. However, these systems have a poor investment efficiency and have not widely spread. Accordingly, most of a digestion gas and a pyrolysis gas are incinerated in practical use even though they have a relatively large heating value.

### SUMMARY OF THE INVENTION

The present invention has been made in view of the above drawbacks. It is, therefore, a first object of the present invention to provide a gas turbine apparatus which can stably combust a combustible gas that has been difficult to utilize, such as a gas having a small heating value, with a compact structure at a low cost.

A second object of the present invention is to provide a gas turbine power generating system which can stably combust a combustible gas that has been difficult to utilize, such as a gas having a small heating value, to generate electric power at a high efficiency with energy of the combustible gas.

According to a first aspect of the present invention, there is provided a gas turbine apparatus which can stably combust a combustible gas that has been difficult to utilize, such as a gas having a small heating value, with a compact structure at a low cost. The gas turbine apparatus has an air compressor for compressing air, a combustor capable of combusting the air compressed by the air compressor, and a first fuel supply system configured to supply a fuel to the combustor. The gas turbine apparatus also has a turbine rotatable by a gas discharged from the combustor, a recuperator for exchanging heat between the air supplied from the air compressor to the combustor and an exhaust gas discharged from the turbine, and a gas introduction device configured to introduce a combustible gas into the exhaust gas discharged from the turbine.

According to the present invention, the combustible gas is introduced into the exhaust gas discharged from the turbine. Thus, a combustible gas that has been difficult to utilize can be stably combusted without pressurization so as to increase the temperature of the exhaust gas flowing into the recuperator. Thus, energy of the combustible gas can be converted into a driving force for the turbine without pressurization. Accordingly, it is possible to utilize the combustible gas with a compact structure at a low cost.

Further, since the combustible gas can be combusted without pressurization, power required for pressurization can be reduced so as to improve the efficiency of the system. Furthermore, since the combustible gas is rapidly mixed, diluted, and combusted with the exhaust gas having a high temperature, it is possible to reduce the amount of thermal NOx produced.

The gas turbine apparatus may further include a second fuel supply system configured to supply a gas having a small heating value as the combustible gas to the gas introduction device. In this case, the gas having a small heating value may have a lower heating value of 25,116 kJ/kg or less. For example, a digestion gas produced in a digestion process of biomass or a pyrolysis gas produced in a gasification process of biomass can be employed as the gas having a small heating value.

It is desirable that the gas turbine apparatus includes a first temperature measuring device for measuring a temperature of the exhaust gas to be introduced into the recuperator and a flow control valve for controlling a flow rate of the combustible gas to be supplied to the gas introduction device so that the temperature of the exhaust gas measured by the first temperature measuring device is less than a predetermined value. With such an arrangement, the temperature of the exhaust gas flowing into the recuperator can be prevented from exceeding allowable temperatures.

The first fuel supply system may be configured to supply a fuel having a large heating value as the fuel to the combustor. Alternatively, the first fuel supply system may be configured to supply a fuel having a large heating value as the fuel to the combustor when the turbine is started and to supply a gas having a small heating value as the fuel to the combustor after the turbine is stably operated. With such configuration, the gas turbine apparatus can be operated merely by supply of the gas having a small heating value. In this case, the gas turbine apparatus may further include a second temperature measuring device for measuring a temperature of the air to be supplied to the combustor. The first fuel supply system may be configured to switch the fuel having a large heating value and the gas having a small heating value based on the temperature of the air measured by the second temperature measuring device. At least one of a liquefied natural gas, a liquefied petroleum gas, a propane gas, kerosene, and light oil can be employed as the fuel having a large heating value.

It is desirable that the gas introduction device includes an ejector for drawing the combustible gas into the exhaust gas by an ejector effect due to the exhaust gas discharged from the turbine. With such an ejector, the combustible gas can be drawn into the exhaust gas without pressurization.

The gas turbine apparatus may further include an exhaust gas pipe interconnecting the gas introduction device and the recuperator.

According to a second aspect of the present invention, there is provided a gas turbine power generating system which can stably combust a combustible gas that has been difficult to utilize, such as a gas having a small heating value, to generate electric power at a high efficiency with energy of the combustible gas. The gas turbine power generating system has the aforementioned gas turbine apparatus and a power generating apparatus for generating electric power with use of high-speed rotation of the turbine in the gas turbine apparatus. According to the present invention, a combustible gas that has been difficult to utilize, such as a gas having a small heating value, can be stably combusted without pressurization to generate electric power at a high efficiency with energy of the combustible gas.

The power generating apparatus may include a permanent magnet power generator coupled to the turbine in the gas turbine apparatus, a converter for converting a high-frequency AC output of the permanent magnet power generator into a DC output, and an inverter for converting the DC output into an AC output having a predetermined frequency and a predetermined voltage and outputting the AC output.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a block diagram showing a gas turbine power generating system according to an embodiment of the present invention.

### DETAILED DESCRIPTION OF THE PREFERRED EMBODIMENTS

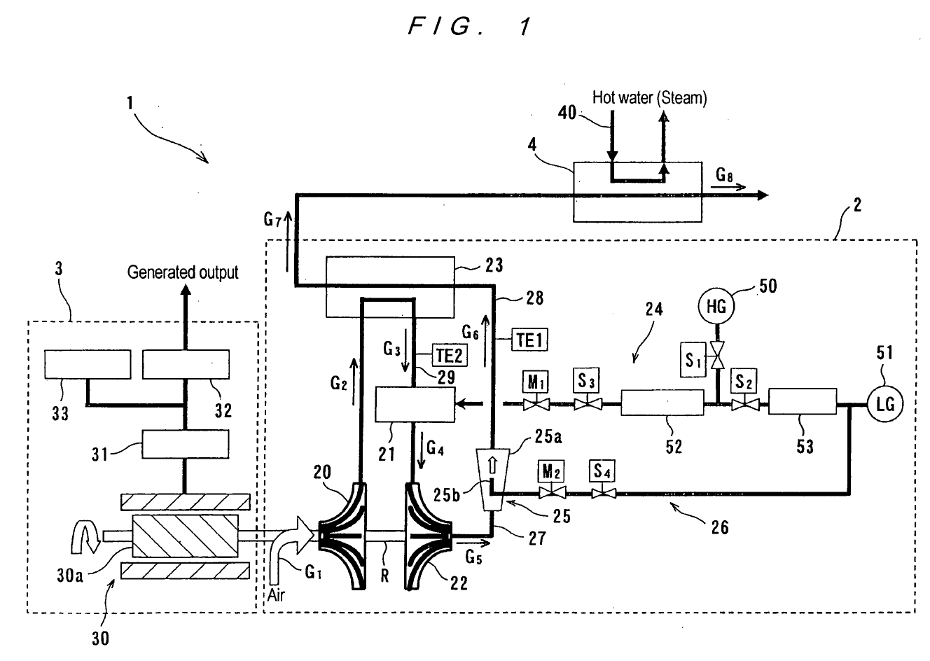

An embodiment of a gas turbine power generating system according to the present invention will be described below with reference to FIG. 1. FIG. 1 is a block diagram showing a gas turbine power generating system 1 according to an embodiment of the present invention. As shown in FIG. 1, the gas turbine power generating system 1 has a gas turbine apparatus 2 for combusting a gaseous mixture of compressed air and a fuel gas, a power generating apparatus 3 for generating electric power with use of high-speed rotation of a turbine in the gas turbine apparatus 2, and an exhaust heat recovery apparatus 4 for recovering exhaust heat from an exhaust gas discharged from the gas turbine apparatus 2.

The gas turbine apparatus 2 includes an air compressor 20 for compressing air, a combustor 21 for mixing and combusting the air compressed by the air compressor 20 and a fuel, a turbine 22 having a plurality of rotational blades, which are rotated at a high speed by a combustion gas discharged from the combustor 21, and a recuperator (heat exchanger) 23 for superheating the compressed air to be supplied to the combustor 21 with use of exhaust heat of an exhaust gas discharged from the turbine 22.

The gas turbine apparatus 2 also includes a first fuel supply system 24 for supplying a fuel to the combustor 21. The first fuel supply system 24 has a supply source 50 of a fuel HG having a large heating value, such as a liquefied natural gas (LNG), a liquefied petroleum gas (LPG), a propane gas, kerosene, or light oil. The first fuel supply system 24 also has a supply source 51 of a gas LG having a small heating value, such as a digestion gas produced in a digestion process of biomass or a pyrolysis gas produced in a gasification process of biomass. The first fuel supply system 24 includes a gas compressor 52 for pressurizing the fuel HG and the gas LG, a dehumidifier 53 for removing moisture from the gas LG, a shut-off valve S₁ for stopping supply of the fuel HC; a shut-off valve S₂ for stopping supply of the gas LG, a shut-off valve S₃ for stopping supply of the fuel HG and the gas LG, and a flow control valve M₁ for controlling a flow rate of a fuel to be supplied to the combustor 21.

As shown in FIG. 1, the gas turbine apparatus 2 includes a gas introduction device 25 for introducing a combustible gas into an exhaust gas discharged from the turbine 22 and a second fuel supply system 26 for supplying the gas LG as a combustible gas to the gas introduction device 25. The second fuel supply system 26 includes the aforementioned supply source 51 of the gas LG, a shut-off valve S₄ for stopping supply of the gas LG, and a flow control valve M₂ for controlling a flow rate of the gas LG to be supplied to the gas introduction device 25.

The power generating apparatus 3 has a power generator 30 coupled directly to a rotation shaft R of the turbine 22, a converter 31 for converting a high-frequency AC output of the power generator 30 into a DC output, an inverter 32 for converting the output of the converter 31 into an AC output having a predetermined frequency and a predetermined voltage, and a battery 33 for driving the power generator 30 so as to serve as a starter motor when operation of the gas turbine apparatus 2 is started. In the present embodiment, a permanent magnet power generator (PMG) is used as the power generator 30, and a pulse width modulation inverter (PWM) is used as the inverter 32.

In the gas turbine power generating system 1 thus constructed, air G₁ is drawn into the air compressor 20 and compressed therein. The compressed air G₂ has a temperature of about 200° C. When the compressed air G₂ passes through the recuperator 23, it is superheated by heat of an exhaust gas discharged from the turbine 22. The heated air G₃ has a temperature of about 700° C. The compressed air G₃ is supplied into the combustor 21 and mixed with a fuel supplied from the first fuel supply system 24. Thus, a gaseous mixture of the compressed air G₃ and the fuel is formed within the combustor 21. The gaseous mixture of the compressed air G₃ and the fuel is combusted in the combustor 21 to produce a combustion gas G₄ having a high pressure and a high temperature of about 900° C.

The combustion gas G₄ produced by combustion in the combustor 21 is supplied to the turbine 22. The turbine 22 receives the combustion gas G₄ and thus rotates at a high speed of, for example, about 68,000 rpm. Since the rotation shaft R of the turbine 22 is connected to the air compressor 20 and a rotor 30a of the power generator 30, the power generator 30 and the air compressor 20 are rotated at a high speed according to the high-speed rotation of the turbine 22. Thus, the air G₁ is compressed by the air compressor 20, and an AC current is generated by the power generator 30.

A high-frequency AC current having a frequency of, for example, about 2,000 Hz is generated in the power generator 30 and rectified into a DC current in the converter 31 of the power generating apparatus 3. The output from the converter 31 is converted into an AC current having a predetermined frequency (e.g., 50 Hz or 60 Hz) and a predetermined voltage by the inverter 32 so that it can be used as a commercial AC current and then externally outputted.

The turbine 22 and the gas introduction device 25 are directly interconnected by an exhaust gas pipe 27. The exhaust gas G₅ discharged from the turbine 22 passes through the exhaust gas pipe 27 into the gas introduction device 25. In the gas introduction device 25, the gas LG having a small heating value is supplied into the exhaust gas G₅ from the second fuel supply system 26. The exhaust gas G₅ discharged from the turbine 22 has a high temperature of about 600° C. and a pressure of at most several kPa. Since the exhaust gas G₅ has a low pressure, the gas LG having a small heating value can be supplied into the exhaust gas G₅ merely by slightly pressurizing the gas LG with a blower. The exhaust gas G₅ has an oxygen concentration of about 18%. Accordingly, the gas LG introduced into the exhaust gas G₅ having a high temperature is rapidly and stably combusted.

In the present embodiment, an ejector is employed as the gas introduction device 25. Specifically, the gas introduction device 25 has a diffuser 25a having a passage widened toward a downstream side and a fuel supply nozzle 25b extending downstream in parallel to a flow of the exhaust gas G₅. The fuel supply nozzle 25b is connected to the second fuel supply system 26. The exhaust gas G₅ has a flow velocity of several tens of meters per second. The fuel supply nozzle 25b of the gas introduction device 25 projects downstream within the flow of the exhaust gas G₅ in parallel to the flow of the exhaust gas G₅. Accordingly, the gas LG in the fuel supply nozzle 25b can be drawn into the exhaust gas G₅ without pressurization by reduction effect of static pressure of the exhaust gas G₅ (ejector effect).

The gas introduction device 25 and the recuperator 23 are directly interconnected by an exhaust gas pipe 28. The exhaust gas G₆ combusted in the gas introduction device 25 has a temperature of about 750° C. and passes through the exhaust gas pipe 28 into the recuperator 23. The exhaust gas G₆ supplied into the recuperator 23 exchanges heat with the compressed air G₂ flowing through a pipe in the recuperator 23 to superheat the compressed air G₂. The exhaust gas G₇ discharged from the recuperator 23 is supplied into the exhaust heat recovery apparatus 4.

For example, the exhaust heat recovery apparatus 4 includes a hot water boiler for exchanging heat between the exhaust gas G₇ discharged from the recuperator 23 and hot water. The exhaust heat recovery apparatus 4 heats hot water circulated through a hot water pipe 40 with heat of the exhaust gas G₇ discharged from the recuperator 23 so as to recover exhaust heat of the exhaust gas G₇. The exhaust gas G₈ that has exchanged heat with the hot water in the exhaust heat recovery apparatus 4 is then discharged to the exterior of the system.

As described above, in the present embodiment, the gas LG having a small heating value is introduced and combusted as a fuel in the gas introduction device 25 to increase the temperature of the exhaust gas G₆ which is to flow into the recuperator 23. Accordingly, the amount of heat exchanged in the recuperator 23 is increased substantially in proportion to the temperature of the exhaust gas G₆ flowing into the recuperator 23. Thus, the temperature of the compressed air G₃ is increased at an outlet of the recuperator 23 (or at an inlet of the combustor 21). For example, if the temperature of the exhaust gas G₆ flowing into the recuperator 23 is 750° C., the temperature of the compressed air G₃ flowing into the combustor 21 reaches at least 700° C. When the temperature of the compressed air G₃ flowing into the combustor 21 is increased, the amount of fuel supplied into the combustor 21 can be reduced. This means that thermal energy of the gas LG having a small heating value is recovered by the recuperator 23 and converted into a driving force for the turbine 22.

An upper limit of allowable temperatures of a gas flowing into the recuperator 23 is determined by a structure or a material of the recuperator 23. Generally, the upper limit is about 750° C. Some special recuperators (e.g., heat exchangers made of nickel alloy) have an upper limit as high as about 950° C. In any case, it is desirable that the temperature of the exhaust gas G₆ flowing into the recuperator 23 does not exceed allowable temperatures of the recuperator 23. For this purpose, a first temperature measuring device TE1 for measuring the temperature of the exhaust gas G₆ may be provided on the exhaust gas pipe 28 between the gas introduction device 25 and the recuperator 23. In this case, the amount of gas LG to be introduced into the gas introduction device 25 may be adjusted by the flow control valve M₂ in the second fuel supply system 26 based on the temperature of the exhaust gas G₆, which is measured by the temperature measuring device TE1.

An increase of the temperature of the compressed air G₃ flowing into the combustor 21 produces an incidental effect. Specifically, the gas LG having a small heating value can be combusted more stably as the gas has a higher temperature. Accordingly, when the temperature of the compressed air G₃ is increased, stable combustion can be maintained even if the gas LG having a small heating value is introduced into the combustor 21. Thus, the gas HG having a large heating value which has been introduced into the combustor 21 can be switched to the gas LG having a small heating value.

More specifically, until the gas turbine apparatus 2 is stably operated (at a rated speed) after the gas turbine apparatus 2 is started, the liquid fuel HG having a large heating value, such as a liquefied natural gas, a liquefied petroleum gas, a propane gas, kerosene, or light oil is supplied into the combustor 21, and the gas LG having a small heating value is supplied into the gas introduction device 25. When the temperature of the compressed air G₃ flowing into the combustor 21 becomes higher than a predetermined value due to combustion of the gas LG in the gas introduction device 25, the shut-off valves S₁, S₂, and S₃ are controlled so as to switch the fuel to be supplied to the combustor 21 from the fuel HG having a large heating value to the gas LG having a small heating value. Thus, the gas turbine apparatus 2 can be operated merely by supply of the gas LG having a small heating value.

Further, if the temperature of the exhaust gas G₆ flowing into the recuperator 23 is increased to about 950° C., it is not necessary to supply a fuel into the combustor 21. Accordingly, operation of the gas turbine apparatus 2 can be continued merely by supply of the gas LG having a small heating value. Since the gas LG having a small heating value can be combusted without pressurization, the gas compressor 52 can be eliminated. Thus, power required for pressurization can be reduced so as to improve the efficiency of the system.

The timing of switching the fuel can be determined based on the temperature of the compressed air G₃ flowing into the combustor 21. Accordingly, a second temperature measuring device TE2 may be provided on a compressed air pipe 29, which interconnects the recuperator 23 and the combustor 21, to measure the temperature of the compressed air G₃.

Although certain preferred embodiments of the present invention have been shown and described in detail, it should be understood that various changes and modifications may be made therein without departing from the scope of the appended claims.

What is claimed is:

1. A gas turbine apparatus comprising:
an air compressor for compressing air;
a combustor capable of combusting the air compressed by said air compressor;
a first fuel supply system configured to supply a fuel to said combustor;
a turbine rotatable by a gas discharged from said combustor;
a recuperator for exchanging heat between the air supplied from said air compressor to said combustor and an exhaust gas discharged from said turbine; and
a gas introduction device configured to introduce a combustible gas into the exhaust gas discharged from said turbine.

2. The gas turbine apparatus as recited in claim 1, further comprising a second fuel supply system configured to supply a gas having a small heating value as the combustible gas to said gas introduction device.

3. The gas turbine apparatus as recited in claim 2, wherein the gas having a small heating value has a lower heating value of 25,116 kJ/kg or less.

4. The gas turbine apparatus as recited in claim 2, wherein the gas having a small heating value comprises at least one of a digestion gas produced in a digestion process of biomass and a pyrolysis gas produced in a gasification process of biomass.

5. The gas turbine apparatus as recited in claim 1, further comprising:
a first temperature measuring device for measuring a temperature of the exhaust gas to be introduced into said recuperator; and
a flow control valve for controlling a flow rate of the combustible gas to be supplied to said gas introduction device so that the temperature of the exhaust gas measured by said first temperature measuring device is less than a predetermined value.

6. The gas turbine apparatus as recited in claim 1, wherein said first fuel supply system is configured to supply a fuel having a large heating value as the fuel to said combustor.

7. The gas turbine apparatus as recited in claim 6, wherein the fuel having a large heating value comprises at least one of a liquefied natural gas, a liquefied petroleum gas, a propane gas, kerosene, and light oil.

8. The gas turbine apparatus as recited in claim 1, wherein said first fuel supply system is configured to supply a fuel having a large heating value as the fuel to said combustor when said turbine is started and to supply a gas having a small heating value as the fuel to said combustor after said turbine is stably operated.

9. The gas turbine apparatus as recited in claim 8, further comprising a second temperature measuring device for measuring a temperature of the air to be supplied to said combustor,
wherein said first fuel supply system is configured to switch the fuel having a large heating value and the gas having a small heating value based on the temperature of the air measured by said second temperature measuring device.

10. The gas turbine apparatus as recited in claim 8, wherein the fuel having a large heating value comprises at least one of a liquefied natural gas, a liquefied petroleum gas, a propane gas, kerosene, and light oil.

11. The gas turbine apparatus as recited in claim 1, wherein said gas introduction device includes an ejector for drawing the combustible gas into the exhaust gas by an ejector effect due to the exhaust gas discharged from said turbine.

12. The gas turbine apparatus as recited in claim 1, further comprising an exhaust gas pipe interconnecting said gas introduction device and said recuperator.

13. A gas turbine power generating system comprising:
a gas turbine apparatus including:
an air compressor for compressing air,
a combustor capable of combusting the air compressed by said air compressor,
a first fuel supply system configured to supply a fuel to said combustor,
a turbine rotatable by a gas discharged from said combustor,
a recuperator for exchanging heat between the air supplied from said air compressor to said combustor and an exhaust gas discharged from said turbine, and
a gas introduction device configured to introduce a combustible gas into the exhaust gas discharged from said turbine; and
a power generating apparatus for generating electric power with use of high-speed rotation of said turbine in said gas turbine apparatus.

14. The gas turbine power generating system as recited in claim 13, wherein said power generating apparatus comprises:
a permanent magnet power generator coupled to said turbine in said gas turbine apparatus;
a converter for converting a high-frequency AC output of said permanent magnet power generator into a DC output; and
an inverter for converting the DC output into an AC output having a predetermined frequency and a predetermined voltage and outputting the AC output.
